(19) United States
(12) Patent Application Publication
(10) Pub. No.: US 2020/0384814 A1
(43) Pub. Date: Dec. 10, 2020

(54) BLUETOOTH TIRE PRESSURE DETECTION DEVICE

(71) Applicant: Chih-Yi Chen, Taipei City (TW)

(72) Inventor: Chih-Yi Chen, Taipei City (TW)

(21) Appl. No.: 16/882,758

(22) Filed: May 26, 2020

(30) Foreign Application Priority Data
Jun. 6, 2019 (TW) 108207213

(51) Int. Cl. B60C 23/04; H04W 4/80; H04W 76/10

(52) U.S. Cl. CPC B60C 23/0433; H04W 4/80; B60C 23/0474; B60C 23/0403; B60C 23/0415; H04W 76/10

(57) ABSTRACT

A tire pressure detection device includes an emitter and a receiver. The emitter is installed to a tire to detect tire pressure, and the emitter sends the tire pressure data via Bluetooth communication to the receiver. The receiver is operated by a user so as to pair the emitter on the tire that is to be checked. The receiver is an elongate part which includes an LF trigger coil connected to the front end thereof. The LF trigger coil is moved to close to the emitter and activates the emitter, such that the tire pressure is sent to the receiver. The emitter has to be paired with the receiver to send the tire pressure to the receiver.

### BACKGROUND OF THE INVENTION

### 1. Fields of the Invention

The present invention relates to a tire pressure detection device, and more particularly, to a tire pressure detection device using Bluetooth communication.

### 2. Descriptions of Related Art

The conventional way to check tire pressure is to connect a tire pressure detector with the valve of the tire. However, this conventional tire pressure detector requires the user to connect the tire pressure detector with the tire valve one by one, and may spend a lot of time if multiple tires need to be checked.

Another conventional tire pressure detector uses wireless technology to obtain the information of the tire pressure. This tire pressure detector includes an emitter and a receiver, wherein the emitter is installed to the tire which detects the tire pressure of the tire, and the detected data of the tire pressure is sent to the receiver by a wireless method.

The detected data of the tire pressure is sent by Sub-1G wireless technology such as 433 MHz/315 MHz wireless signal band. However, the signals can easily be interfered. Therefore, this type tire pressure detectors are usually used to vehicles with two or four wheels. Trucks and trailers have more than eight wheels are not suitable for this type tire pressure detectors because the wheels are arranged side by side, so that the emitter of the adjacent tire may be wrongly activated when the user tries to check the other one. In some situations, the outer tire may have to removed, so as to receive the tire pressure signal of the inner tire.

The present invention intends to provide a tire pressure detection device using Bluetooth communication so as to eliminate the shortcomings mentioned above.

### SUMMARY OF THE INVENTION

The present invention relates to a tire pressure detection device and comprises an emitter installed to a tire so as to detect tire pressure of the tire. The emitter sends tire pressure data via Bluetooth communication to a receiver. The receiver pairs the emitter by Bluetooth communication, and receives the tire pressure data sent from the emitter.

Preferably, the receiver includes an LF trigger coil connected to the front end thereof, and the LF trigger coil is moved to close the tire and activates the emitter.

Preferably, the receiver is an elongate part and the LF trigger coil is connected to the front end of the receiver so as to be inserted through a narrow space and be located close to the emitter.

Preferably, the emitter includes an identification code, and the receiver pairs the emitter by identifying the identification code, so that the specific tire pressure is detected.

Preferably, the receiver includes a Liquid Crystal Display to display the identification code and the tire pressure data.

The primary object of the present invention is to provide a tire pressure detection device that uses Bluetooth communication between the emitter and the receiver so as to avoid from being interfered.

Another object of the present invention is to provide a tire pressure detection device wherein each emitter has an identification code, and the receiver pairs the emitter by the identification code so as to correctly check the tire pressure of the specific tire.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the tire pressure detection device of the present invention;

FIG. 2 shows the components of the tire pressure detection device of the present invention, and

FIG. 3 shows the operating steps of tire pressure detection device of the present invention.

### DETAILED DESCRIPTION OF THE PREFERRED EMBODIMENT

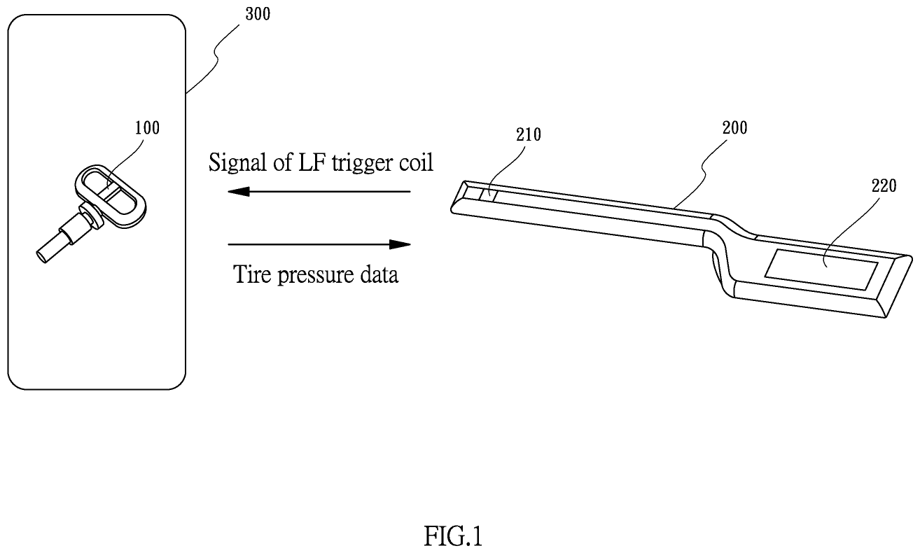

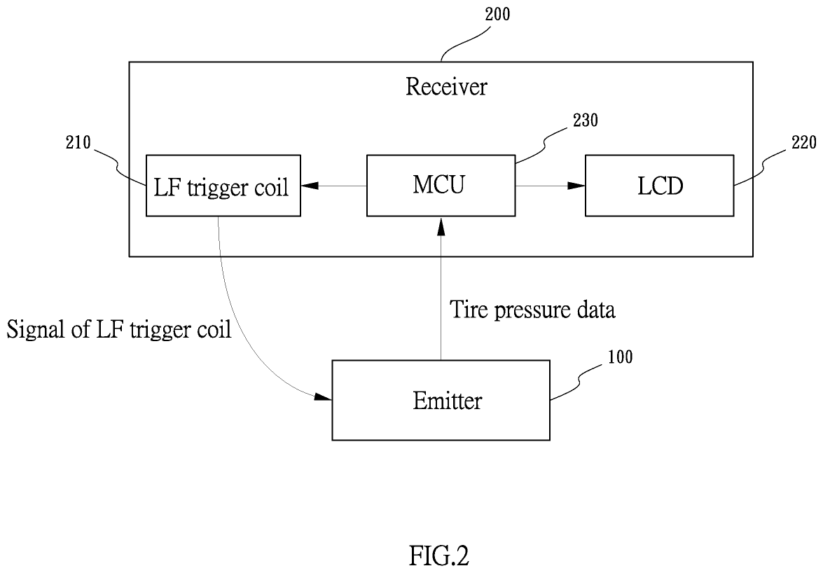

Referring to FIGS. 1 to 3, the tire pressure detection device of the present invention comprises at least one emitter 100 and a receiver 200 which communicates with the emitter 100 by Bluetooth communication. Each tire 300 has one emitter 100 installed thereto, so as to detect tire pressure. The emitter 100 can be installed to outside or inside of the tire 300. The emitter 100 sends the tire pressure data via Bluetooth communication to the receiver 200.

The receiver 200 pairs the selected emitter 100 by Bluetooth communication, and receives the tire pressure data sent from the selected emitter 100. The receiver 200 is an elongate part and an LF trigger coil 210 is connected to the front end of the receiver 200 so as to be located close to the emitter 100. The LF trigger coil 210 activates the emitter 100.

Specifically, each emitter 100 includes an identification code, and the receiver 200 pairs the emitter 100 by identifying the identification code. Therefore, only the selected emitter 100 can be activated. The receiver 200 includes a Liquid Crystal Display (LCD) 220 located close to the rear end of the receiver 200 to display the identification code and the tire pressure data.

The elongate receiver 200 is held by the user and can easily inserted into narrow space between tires 300 so as to move the LF trigger coil 210 close to the selected emitter 100.

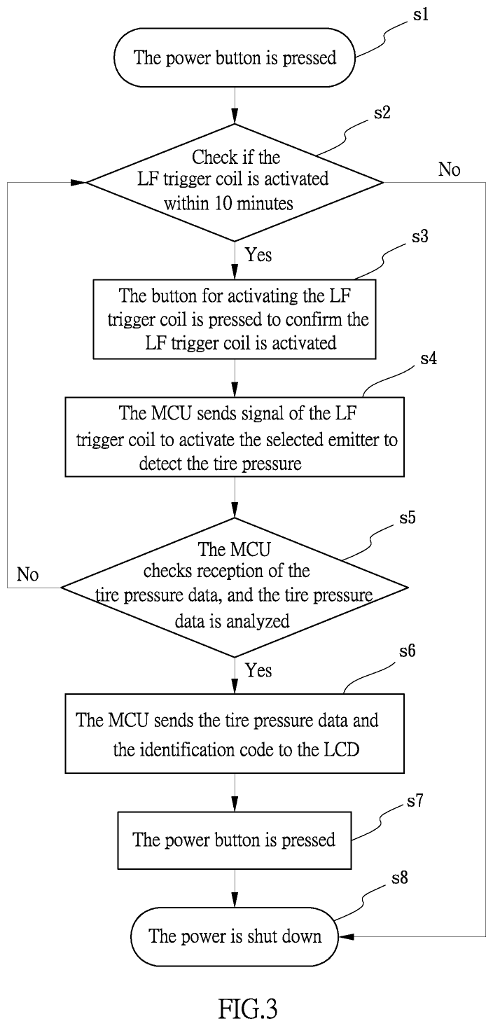

The LF trigger coil 210 and the LCD 220 can be controlled by a Micro Control Unit (MCU) 230. As shown in FIG. 3, the steps for operating the tire pressure detection device of the present invention comprises:

Step 1 (s1): The user holds the receiver 200 and presses the power button to activate the receiver 200.

Step 2 (s2): The receiver 200 includes a timer to check if the LF trigger coil 210 is activated within 10 minutes after the power button is pressed, or the power is automatically shut down.

Step 3 (s3): The button for activating the LF trigger coil 210 is pressed to confirm the LF trigger coil 210 is activated.

Step 4 (s4): The MCU 230 sends signal of the LF trigger coil 210 to activate the selected emitter 100 to detect the tire pressure, and the fire pressure data that is detected is sent to the receive 200.

Step 5 (s5): The MCU 230 checks reception of the tire pressure data, if no tire pressure data is received, to back to the step 2 (s2), if the tire pressure data is received, the tire pressure data is analyzed.

Step 6 (s6): The MCU 230 sends the tire pressure data and the identification code to the LCD 220.

Step 7 (s7): The power button is pressed when the user acknowledges the tire pressure.

Step 8 (s8): The power is shut down.

While we have shown and described the embodiment in accordance with the present invention, it should be clear to those skilled in the art that further embodiments may be made without departing from the scope of the present invention.

What is claimed is:

1. A tire pressure detection device comprising:
an emitter adapted to be installed to a tire to detect tire pressure, the emitter sending tire pressure data via Bluetooth communication, and
a receiver pairing the emitter by Bluetooth communication, and receiving the tire pressure data sent from the emitter.

2. The tire pressure detection device as claimed in claim 1, wherein the receiver includes an LF trigger coil connected to a front end thereof, the LF trigger coil activates the emitter.

3. The tire pressure detection device as claimed in claim 2, wherein the receiver is an elongate part and the LF trigger coil is connected to the front end of the receiver so as to be located close to the emitter.

4. The tire pressure detection device as claimed in claim 1, wherein the emitter includes an identification code, the receiver pairs the emitter by identifying the identification code.

5. The tire pressure detection device as claimed in claim 4, wherein the receiver includes a Liquid Crystal Display to display the identification code and the tire pressure data.
